(19) United States
(12) Patent Application Publication
(10) Pub. No.: US 2010/0058409 A1
(43) Pub. Date: Mar. 4, 2010

(54) Audio and video testing methodology

(75) Inventors: Mark Chapman, Irvine, CA (US); Scott Griffith, San Clemente, CA (US); Dan Stack, Foothill Ranch, CA (US); Tony Vittimberga, Aliso Viejo, CA (US)

Correspondence Address: WILMERHALE/BOSTON, 60 STATE STREET, BOSTON, MA, 02109, US

(73) Assignee: Comarco Wireless Technologies, Inc., Lake Forest, CA (US)

(21) Appl. No.: 12/231,235

(22) Filed: Aug. 29, 2008

(51) Int. Cl. H04N 7/173

(52) U.S. Cl. 725/106; 725/107

(57) ABSTRACT

A centralized audio video testing system utilizes a remote client device. The remote client device includes a decoder, a renderer, a media engine, a video capture module and a frame module. The decoder receives a transmitted video stream from a video streaming server and to generate a decoded video stream. The renderer receives the decoded video stream and generates a rendered video stream that is able to be displayed on a display of the remote client device. The media engine receives the rendered video stream and plays the rendered video stream on a media player resident on the remote client device. The video capture module captures frames of the played rendered video stream. The frame manager receives the captured frames of the played rendered video streams and creates a degraded streaming video file.

### BACKGROUND OF THE INVENTION

1. Field of the Invention

This invention relates generally to audio and video network testing and specifically to centralized network testing of streaming video, audio and video telephony.

2. Description of Related Art

End-to-end testing of voice, data and video is utilized to identify data quality scores, video quality scores, and voice quality scores. FIG. 1 illustrates a system for performing end-to-end voice, data, and video quality scoring according to the prior art. Existing end-to-end testing where remote devices receive voice, data and video files and the remote devices computer voice, data and video quality scores based on the received files. FIG. 1 illustrates a system for performing end-to-end testing. The system 100 includes a land unit 110, a data device 120, a multi-media server 130 capable of video streaming, and a receiving device 140. The system also may include a PSTN or ISDN telephone circuit switched network 150, a global packet-switched network, (e.g., the Internet) 160 and a cellular network 170. The receiving device 140 includes voice testing software 180, data testing software 185 and video testing software 190. The land unit 110 includes audio which is transmitted (e.g., downlinked) through the PSTN/ISDN network 150 to the cellular network 170. The audio is then transferred through the cellular network 170 to the receiving device 140. The receiving device 140 utilizes the voice testing software to determine an audio quality score for the cellular network 170 in conjunction with the PSTN/ISDN 150. The receiving device 140 may utilize a reference file in determining the audio quality score the network(s). The audio quality score is determined remotely at the receiving device 140.

For data testing, a file is housed in the data device 120 and is transmitted via the Internet 160 and via the cellular network 170 to the receiving device 140. The receiving device 140 includes data testing software 185 to determine a data quality score for the received data file. A reference data file, stored on the receiving device 140, may be utilized in determining the data quality score for the data file. The data quality score is determined remotely at the receiving device 140.

A video streaming file is housed in the multi-media server 130. A receiving device 140 initiates an internet connection with the multi-media server 130 through the cellular network 170 and the Internet 160. A uniform resource locator corresponding to the location of a streaming video file is input into a web browser on the receiving device 140. A connection is then made between the multi-media server and the receiving device and the streaming video file is downloaded on a frame-by-frame basis to the receiving device 140. The receiving device receives the frames of the streaming video file and display the streaming video file on a display of the receiving device 140. After display of the streaming video file, the receiving device 140 stores the frames of the streaming video file. A video quality score is determined from the stored frames of the video receiving device 140.

Each of the above-described methods requires that the receiving device includes voice testing software, data testing software or video testing software. In addition, there may be additional scoring software that the receiving device may required to be stored on the receiving device. Including this software on the receiving device 140 reduces the processing power available for other receiving device tasks. In addition, the requirement of testing software being installed on each receiving device utilized within a network requires a large expenditure of money.

### BRIEF DESCRIPTION OF THE DRAWINGS

FIG. 1 illustrates a system for performing end-to-end voice, data, and video quality scoring according to the prior art;

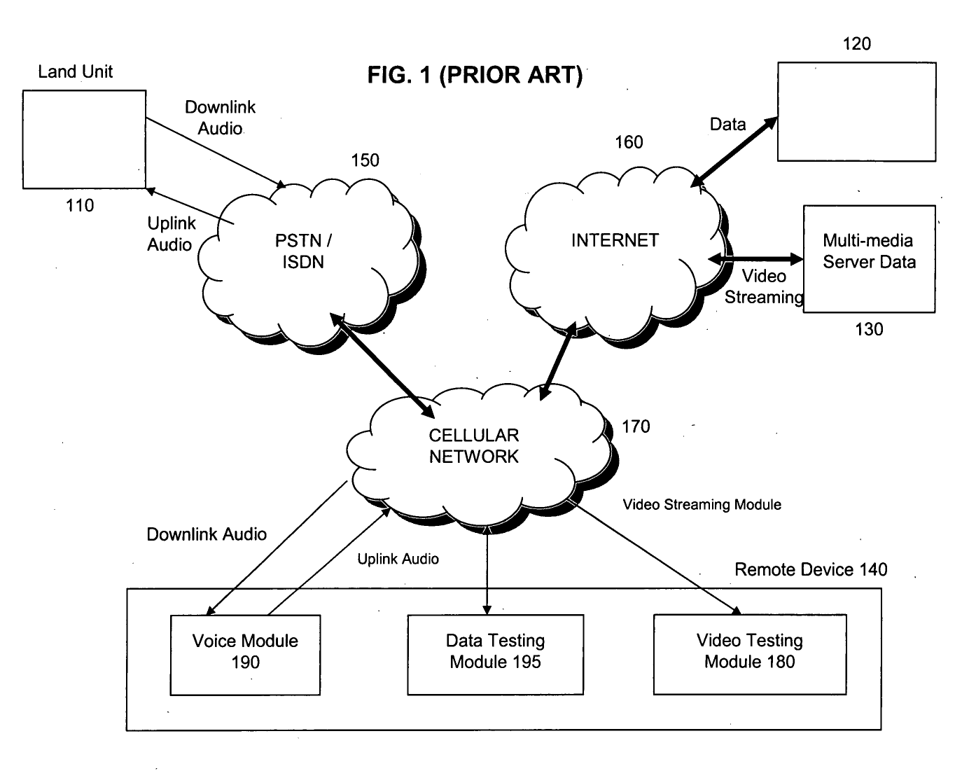

FIG. 2 illustrates a system for performing centralized network testing for streaming video according to an embodiment of the invention;

FIG. 3 illustrates a method for performing centralized network testing according to an embodiment of the invention;

FIG. 4 includes an centralized audio testing system according to an embodiment of the present invention;

FIG. 5 illustrates a method for performing centralized audio testing according to an embodiment of the invention;

FIG. 6 illustrates a centralized network testing system for video telephony according to an embodiment of the invention;

FIG. 7 illustrates a method for centralized network testing system for video telephony according to an embodiment of the invention; and

FIG. 8 illustrates a block diagram of a remote device implementing a capture algorithm according to an embodiment of the invention.

### DETAILED DESCRIPTION OF THE INVENTION

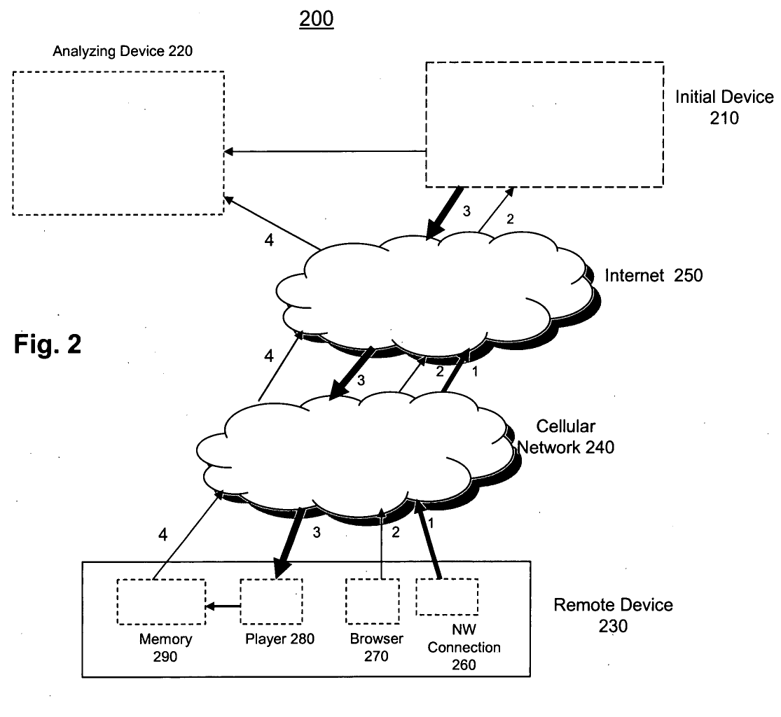

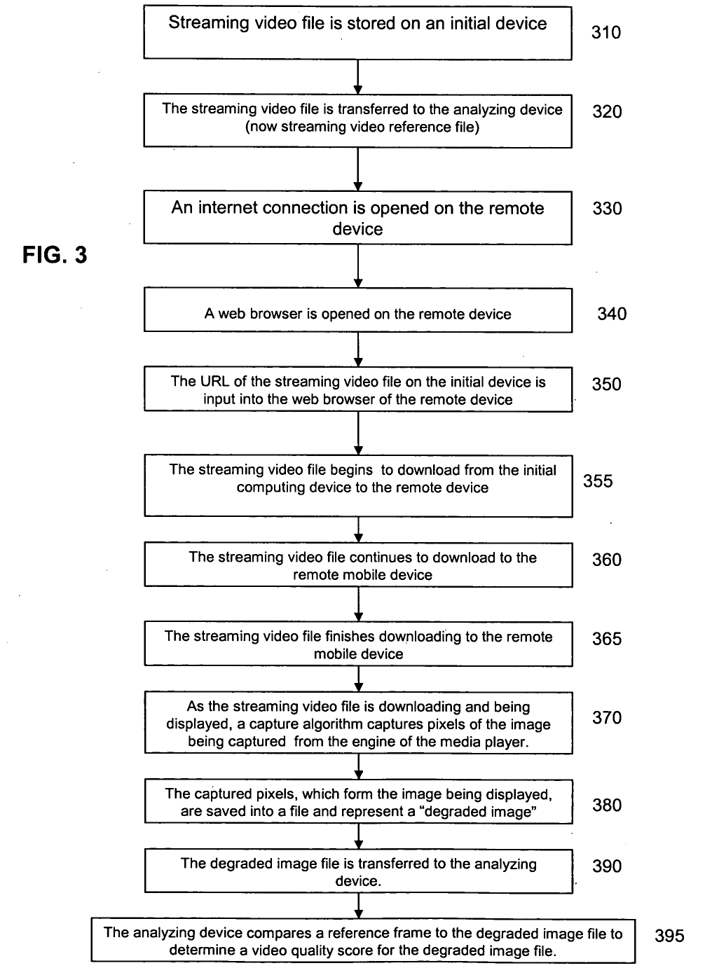

FIG. 2 illustrates a system for performing centralized network testing for streaming video according to an embodiment of the invention. FIG. 3 illustrates a method for performing centralized network testing for streaming video according to an embodiment of the invention. As illustrated in FIG. 2, the test system 200 includes an initial device 210, an analyzing device 220 and a remote device 230. The system 200 may also include a cellular network 240 and a global data communications network 250, e.g., the Internet.

In an embodiment of the invention, the initial device has a streaming video file stored 310 at a certain location. Under certain operating conditions, the initial device 210 may be a computer and other operating conditions, the initial device may be a mobile device, a server or a laptop computer. The initial device 210 may be referred to as a multimedia server.

A copy of the streaming video file is transferred 320 to the analyzing device 220. The copy of the streaming video file is stored in the analyzing device 220 and may be referred to as the streaming video reference file. The copy of streaming video file may be transferred via the global communications network 250 and may be transferred utilizing any wired or wireless networking protocol.

On the remote device 230, a network connection software module 260 opens or enables an internet connection 330. A web browser 270 is opened 340 on the remote device 230. A uniform resource letter (URL) corresponding to the location of the streaming video file on the initial device 210 is input 350 to the web browser 270. When the URL is input, a connection is then made to the initial device 210 through the Internet, as is illustrated by reference number 2. The streaming video then starts to download 355 from the initial device 210 to the remote device 230. Under certain operating conditions, the streaming video passes through the Internet 250 and the cellular network 240 before arriving at the remote device 230, as is illustrated by reference number 3.

The streaming video file starts 355 to download from the initial device to the remote device. The streaming video file then continues 360 to download the remote device. After a period of time, the streaming file finishes 365 downloading to the remote device 230. As the streaming file is being downloaded from initial device and being received at the remote device, the streaming video file is loaded into a media player module 280 at the remote device 230. The media player 280 then transmits frames of the streaming video file to be displayed on a display of the remote device.

As the streaming video file is downloading and being displayed on the remote device 230, a capture algorithm captures 370 pixels of the image being generated from the engine of the media player 280. In other words, a frame including pixels is captured using a capture algorithm. Alternatively, a number of frames are captured using iterations of the capture algorithm. In an embodiment of the invention, a Helix media player is outputting the pixels (i.e., a frame) to the display of the remote device 230 while the capture algorithm is capturing the pixel data that has been generated and then generating an extra copy of the pixels.

The captured pixels, which are the same pixels that form the image being displayed, are saved 380 into a file in a memory 290 on the remote device and represent a “degraded image.” The image represents a “degraded image” because the image quality has likely been reduced due to losses/errors caused by transmission of the streaming video file over the cellular network 240 or the Internet 250. Under certain operating conditions, one or more frames of the streaming video file may be saved to memory 290 in the remote device create the degraded file. Under certain operating conditions, video is being captured to memory at a predefined frame rate for a predefined length of time. Depending on the predefined length of time, a certain number of frames are captured. A predefined color depth (e.g., bits per pixel) may be captured of each frame.

The degraded image file, which corresponds to the stored frames of pixels, is transferred 390 to the analyzing device 220. The degraded image file is transmitted via a wired or wireless network protocol. The degraded image file is transferred from the remote device 230 through the cellular network 240 and the global communications network 250 to the analyzing device 220, as is illustrate by reference number 4.

The analyzing device may be a laptop computer, a server, or a computing device. The analyzing device compares 395 a reference frame or frames (which may have been transferred from the computing device) to the degraded image file to determine a video quality score for the degraded image file.

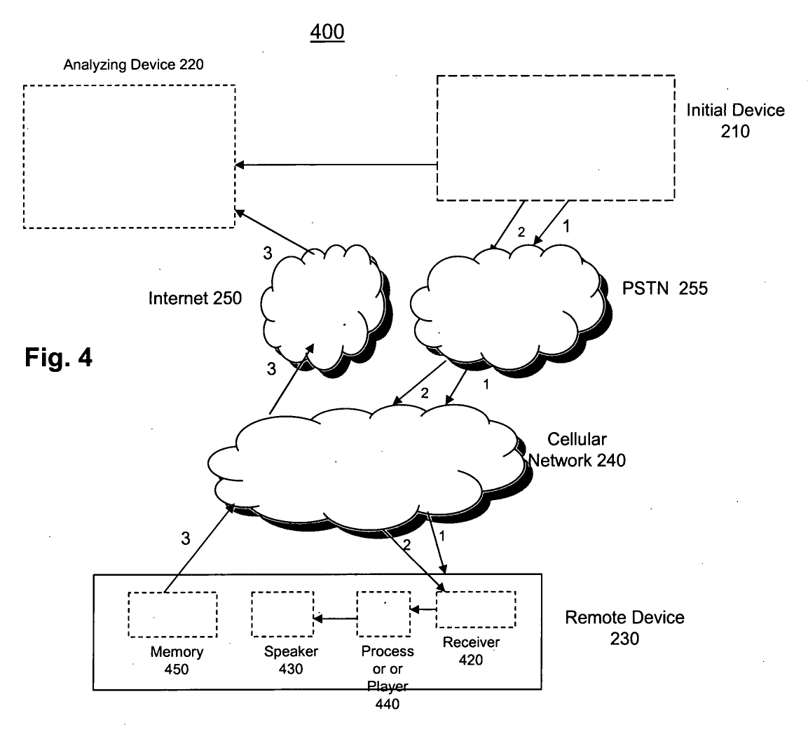

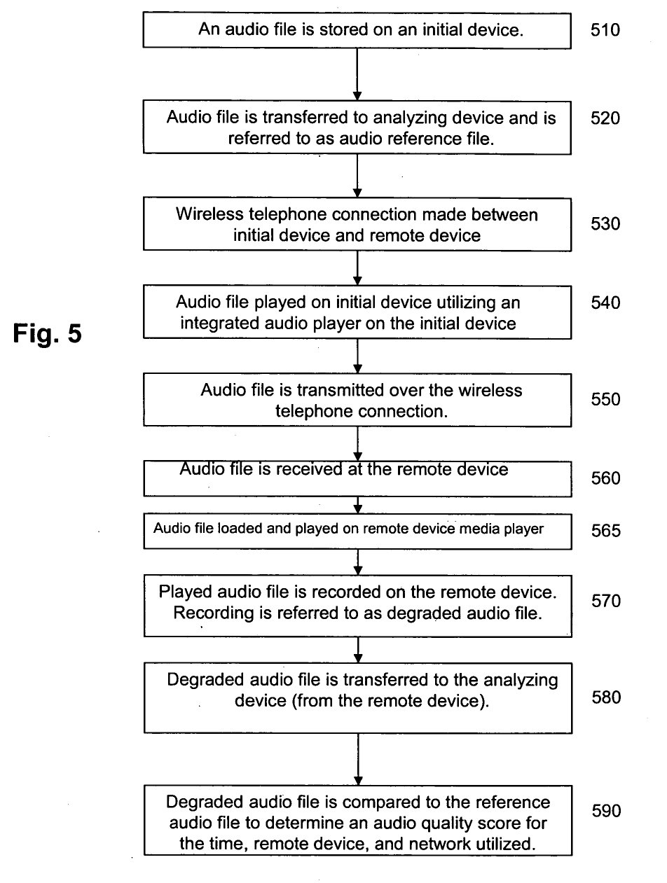

FIG. 4 includes an centralized audio testing system 400 according to an embodiment of the present invention. FIG. 5 illustrates a method for performing centralized audio testing according to an embodiment of the invention. An audio file is stored 510 on an initial device 210. After the audio file is stored on the initial device 210, the audio file is transferred 520 to an analyzing device 220. The audio file on the analyzing device 220 is referred to as an audio reference file.

A wireless telephone connection is made 530 between the initial device 210 and the remote device 230. In an embodiment of the invention, the initial device 210 initiates the call through the public telephone switched network 255 and then through the cellular or wireless network 240 to the remote device 230. This is illustrated by reference number 1 in FIG. 4. In an alternative embodiment of the invention, which is not illustrated in FIG. 4, the initial device 210 initiates the call through the Internet 250 and then through the cellular or wireless network 240 to the remote device 230.

After the wireless telephone connection is made between the initial device 210 and the remote device 230, an audio file is played 540 on the initial device 210. In order to play the audio file, the initial device may have an integrated audio player where the audio file is played. Alternatively, the initial device 210 may include an audio processor and a speaker. The audio file is transmitted or played 550 via the PSTN 255 and cellular network 240 with a wireless telephone connection and the remote device 230 receives 560 the audio file at a receiver 420. This is illustrated by reference number 2 in FIG. 4. The received audio file is processed by an audio processor or media player and played 565 on a speaker 430. In other words, it is not transferred as a downloaded file to be played at a different time, instead the audio file is transmitted like a user's voice communication over the wireless connection.

As the audio file is played on the speaker 430 by an audio processor or media player 440, the received audio file is recorded 570 into a memory 450 on the remote device 230. The recorded audio file may be referred to as the degraded audio file because it is an audio file after the file has been played over the wireless connection and thus is subject to any transmission errors or degradation in the wireless or cellular network 240.

The degraded audio file is then transferred 580 to the analyzing device 220 from the remote device 230. In addition, positional information and time information may be transferred with the degraded audio file to identify when the audio file was captured or stored and where the audio file was captured, i.e., over what network and at what geographical location. The transferring of the degraded audio file is illustrated as reference number 3.

At the analyzing device 220, the degraded audio file is compared 590 to the reference audio file to determine an audio quality score for the time, remote device, and network utilized. One of the testing algorithms may be a PESQ audio testing methodology.

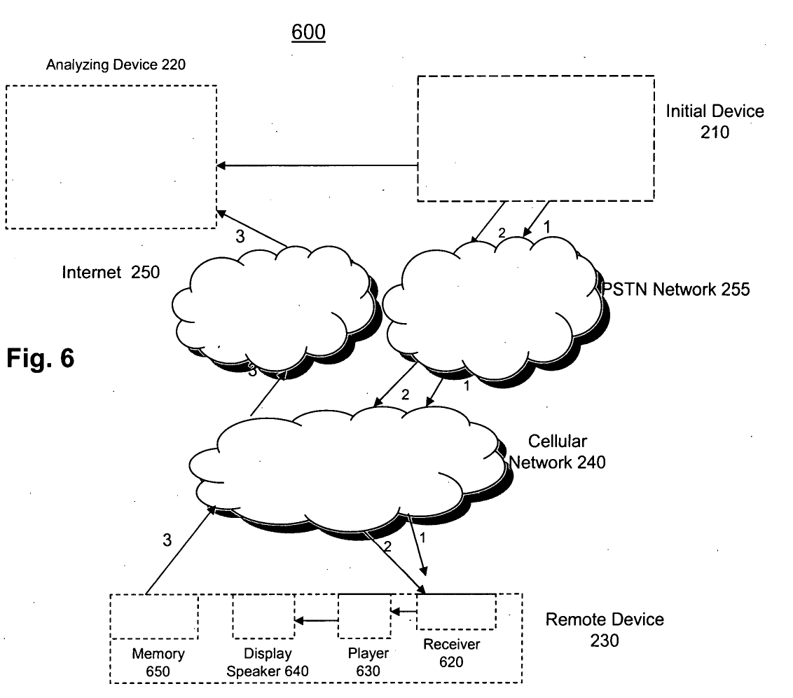

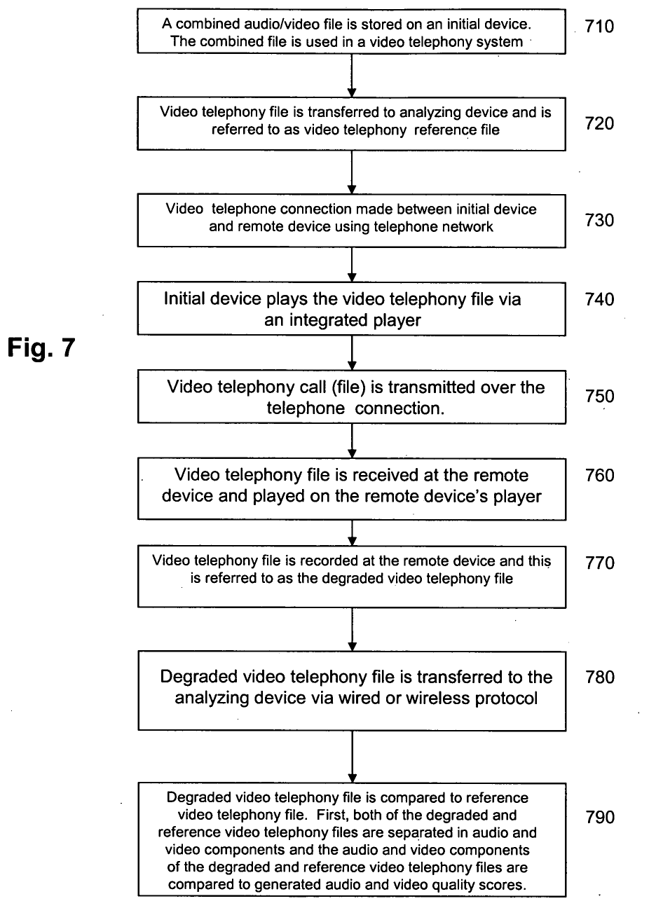

FIG. 6 illustrates a centralized network testing system for video telephony according to an embodiment of the invention. FIG. 7 illustrates a method for centralized network testing system for video telephony according to an embodiment of the invention.

A combined audio/video file is stored 710 on an initial device 210. The combined file is used in a video telephony system. For the remainder of this application, the combined audio/video file is referred to as a video telephony file.

The video telephony file is transferred 720 to an analyzing device 220. The video telephony file transferred to the analyzing device 220 is referred to as a video telephony reference file.

In an embodiment of the invention, a video telephone connection made 730 between initial device 210 and the remote device 230 using the telephone network 255 and cellular network 240. This is illustrated by reference number 1 in FIG. 6. In an embodiment of the invention, the video telephone connection made between the initial device 210 and the remote device 230 is made directly through the cellular network 240, especially if the initial device 210 is a cellular phone or wireless device. In an embodiment of the invention, the video telephone connection made between the initial device 210 and the remote device 230 is made through the Internet 250 and then the cellular network 240.

After the video telephone connection is made, an initial device 210 plays 740 the video telephony file via an integrated player or a video telephony player.

The video telephony call is transmitted 750 over the established telephone connection to the remote device 230. The video telephony file is received 760 at a receiver 620 at the remote device 230. The receiver 620 transfers the receive video telephony call to a video telephony player 630 which plays the integrated audio and video via a display and speaker 640 on the remote device 230. This is illustrated by reference number 2 in FIG. 6.

The received and played video telephony call is recorded 770 at the remote device 230 and stored in a memory 650 in the remote device. The stored call is referred to as the degraded video telephony file.

The degraded video telephony file is transferred. 780 from the remote device 230 to the analyzing device 220 via wired or wireless protocol. The path followed is illustrated by reference number 3 in FIG. 6 and passes through the cellular network 240 and the global communications network 250.

The degraded video telephony file is compared 790 to the reference video telephony file. First, both of the degraded and reference video telephony files are separated in audio and video components and the audio and video components of the degraded and reference video telephony files are compared with each other to generate separate audio and video quality scores. In an embodiment of the invention, a combined audio and video quality score may also be calculated.

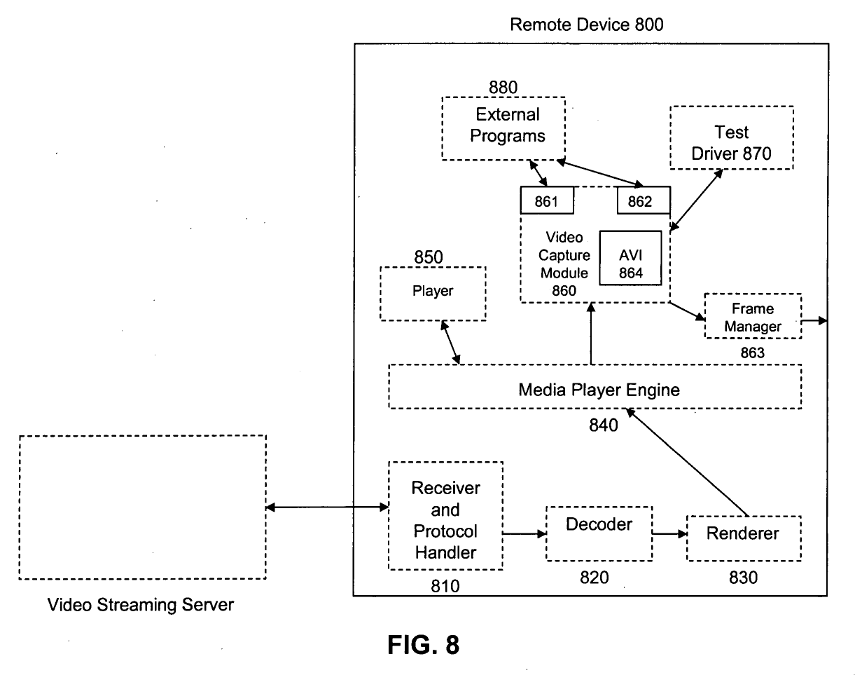

FIG. 8 illustrates a remote device using a capture algorithm according to an embodiment of the invention. The capture algorithm may be utilized for centralized network testing for streaming video. The remote device 800 includes a network real time streaming protocol (RTSP) module 810, a decoder 820, a renderer 830, a helix engine 840, a symbian player 850, a Comarco video capture module 860, a test driver 870 and quota software 880. The remote device 800 receives a content file (e.g., a number of frames) from a video streaming server, (e.g., a Helix or Darwin server) over the network utilizing TCP/IP protocol. The content file is received at the Network RTSP module 810 and is transferred to the decoder 820 where the content file is decoded into a video file. The decoder 820 takes the decoded video file and transfers the decoded video file to a renderer 830 which creates a rendered file that is able for display on a display of the remote device.

The rendered video file is transferred to an engine of a media player 840, e.g., a Helix engine, and then is played, one frame at a time, on the media player 850, e.g., a Symbian player. As the frame is being sent from the engine 840 to the media player 850, a Comarco capture module 860 captures a copy of the frame being displayed by the media player 850. The Comarco capture module 860 may be a dynamic link library (DLL). The Comarco capture module 860 includes a control interface 861, a frame manager 862, an AVI processor 863 and a statistics interface 864. The frame manager 862 stores the captured frame information and assists in managing the display and/or transfer of the frames. The control interface 861 of the Comarco capture module 860 allows external programs, e.g., like an automated test system (Comarco's Quota system), to utilize the dynamic link library. The statistics interface 862 allows eternal programs, e.g., Comarco's Quota system, to access various video metrics. This video metrics include, but are not limited to, bit error rate, frame loss, etc. The video metrics are provided by the Comarco capture module 860 DLL. The audio video interleaved (AVI) processor 864 of the Comarco capture module 860 DLL is the processor utilized by the Comarco Capture module to process, analyze and synchronize both the captured audio and video. In an embodiment of the invention, a test driver 870 is provided for testing and debugging. In this embodiment of the invention, the Comarco capture module 860 does not have a user interface so the test driver 870 provides the user interface. The Comarco capture module 860 transfers the captured and stored frame(s) to Quota testing software module 880 on the remote device. The Quota testing software 880 module transfers the captured and stored frame(s) to the analyzing device.

The invention may be implemented in hardware or software, or a combination of both (e.g., programmable logic arrays). Unless otherwise specified, the algorithms included as part of the invention are not inherently related to any particular computer or other apparatus. In particular, various general purpose machines may be used with programs written in accordance with the teachings herein, or it may be more convenient to construct more specialized apparatus (e.g., integrated circuits) to perform particular functions. Thus, the invention may be implemented in one or more computer programs executing on one or more programmable computer systems each comprising at least one processor, at least one data storage system (which may include volatile and non-volatile memory and/or storage elements), at least one input device or port, and at least one output device or port. Program code is applied to input data to perform the functions described herein and generate output information. The output information is applied to one or more output devices, in known fashion.

Each such program may be implemented in any desired computer language (including machine, assembly, or high level procedural, logical, or object oriented programming languages) to communicate with a computer system. In any case, the language may be a compiled or interpreted language.

Each such computer program is preferably stored on or downloaded to a storage media or device (e.g., solid state memory or media, or magnetic or optical media) readable by a general or special purpose programmable computer, for configuring and operating the computer when the storage media or device is read by the computer system to perform the procedures described herein. The inventive system may also be considered to be implemented as a computer-readable storage medium, configured with a computer program, where the storage medium so configured causes a computer system to operate in a specific and predefined manner to perform the functions described herein.

A number of embodiments of the invention have been described. Nevertheless, it will be understood that various modifications may be made without departing from the spirit and scope of the invention. For example, some of the steps described above may be order independent, and thus can be performed in an order different from that described. Accordingly, other embodiments are within the scope of the following claims.

What is claimed is:

1. A method of centralized network testing, comprising:
receiving a reference multimedia file at a computing device;
receiving a degraded multimedia file at the computing device, where in the degraded multimedia file was first transmitted over a wireless network to a remote device, played on the remote device, recorded as the degraded multimedia file on the remote device and then transferred from the remote device to the computing device; and
comparing the degraded multimedia file to the reference multimedia file to determine a multimedia quality score at a specific point in time for the wireless network, wherein the degraded multimedia file is the reference multimedia file subject to degradation due to the transmission characteristics of the first wireless network.

2. The method of claim 1, wherein the degraded multimedia file and the reference multimedia file are both audio files.

3. The method of claim 1, wherein the degraded multimedia file and the reference multimedia file are both video telephony files.

4. The method of claim 1, wherein the degraded multimedia file and the reference multimedia file are both streaming video files generated from a video stream.

5. The method of claim 4, wherein the degraded video file is captured at a remote device by a video capture module at substantially the same time streaming video corresponding to the degraded video file is played on the remote device.

6. A method of capturing a degraded streaming video file, comprising:
receiving a degraded streaming video stream at a remote device;
transferring the received degraded streaming video stream to a media player in the remote device and playing frames of the received degraded multimedia stream on the media player;
capturing the played frames of the degraded multimedia stream utilizing a video capture module; and
transferring the captured frames of the degraded multimedia stream to a frame manager to create a degraded streaming video file.

7. The method of claim 6, further including transmitting the degraded streaming video file to a testing device.

8. The method of claim 6, further including analyzing the degraded streaming video file at the testing device to create transmission quality statistics.

9. A remote client device, including:
a decoder to receive a transmitted video stream from a video streaming server and to generate a decoded video stream;
a renderer to receive the decoded video stream and to generated a rendered video stream that is able to be displayed on a display of the remote client device;
a media engine to receive the rendered video stream and to play the rendered video stream on a media player resident on the remote client device;
a video capture module to capture frames of the played rendered video stream; and
a frame manager to receive the captured frames of the played rendered video streams and to create a degraded streaming video file.

10. The remote client device of claim 9, further including a control interface to allow external programs to access and control the video capture module.

11. The remote client device of claim 9, wherein the video capture module and the frame manager generate video quality metrics for the played rendered video stream.

12. The remote client device of claim 11, wherein a statistics interface allows external programs to access or retrieve the generated video quality metrics.

13. The remote client device of claim 11, wherein a test driver is utilized to test the video capture module, to debug the video capture module and to provide a user interface for the video capture module.

14. A centralized streaming video testing system, comprising:
an initial device to store a video stream, to transfer the video stream, and to transmit the video stream utilizing an established internet connection;
an analyzing device to receive the video stream and to store the video stream as a streaming video reference file;
a remote device to initiate the established internet connection, to open a web browser having a universal remote locater corresponding to a server housing the video stream, to download the video stream that is being transmitted from the initial device, to play the downloaded video stream on an integrated media player, to capture frames of the downloaded video stream from an engine of the integrated media player, to store the capture frames as a degraded streaming video file, and to transmit the degraded streaming video file, wherein the analyzing device receives the degraded streaming video file and compares the reference video streaming file to the degraded streaming video file to determine a video quality score.

15. The centralized streaming video system of claim 14, wherein the downloaded video stream first passes through the Internet and then through a cellular network.

16. The centralized streaming video system of claim 14, wherein the playing of the downloaded video stream on the integrated media player of the remote device occurs at substantially a same time as the capture of the frames of the downloaded video by a capture module.

17. The centralized streaming video system of claim 14, wherein the frames of the downloaded streaming video file are captured at a predetermined rated for a predetermined time.

18. The centralized streaming video system of claim 14, wherein the frames of the downloaded streaming video file are captured at a different color depth than a color depth at which the frames are downloaded.

19. A centralized audio testing system, comprising:
an initial device to store an audio file, to transfer a copy of the audio file and to separately transmit the audio file;
an analyzing device to receive the copy of the transferred copy of the audio file and to stored the transferred copy as an audio reference file; and
a remote device to receive the transmitted audio file, to play the received audio file via a media player on the remote device, to record the played audio file as a degraded audio file and to transfer the degraded audio file to the analyzing device, wherein the analyzing device compares the degraded audio file to the reference audio file to determine an audio quality score.

20. The centralized audio testing system of claim 19, wherein the initial device transmits the audio file over the public switched telephone network to the wireless network and then to the remote device.

21. The centralized audio testing system of claim 19, wherein the initial device transmits the audio file via the Internet to the wireless network and then to the remote device.

22. The centralized audio testing system of claim 19, wherein the remote device receives the transmitted audio file at a receiver and plays the audio file on a speaker utilizing an audio processor.

23. A centralized video telephony testing system, comprising:
an initial device to generate a combined audio/video file, to transfer a copy of the combined audio/video file and to play a copy of the combined audio/video file over an established video telephone connection utilizing a media player resident on the initial device;
an analyzing device to receive the copy of the combined audio/video file and to store the transferred copy as an reference video telephony file;
a remote device to receive the played copy of the combined audio/video file via the established video telephone connection, to play the received copy of the combined audio/video file via an integrated media player, to record the played received copy of the combined audio/video file as a degraded video telephony file and to transmit the degraded video telephony file to the analyzing device, wherein the analyzing device compares the degraded video telephony file to the reference video telephony file to determine a video telephony quality score.

24. The centralized video telephony testing system of claim 23, wherein the established video telephone connection utilizes only a cellular network because the initial device is a cellular phone.

25. The centralized video telephony testing system of claim 23, wherein the established video telephone connection utilizes a telephone network.
